(19) United States
(12) Patent Application Publication
(10) Pub. No.: US 2022/0243015 A1
(43) Pub. Date: Aug. 4, 2022

(54) SILICONE COMPOSITION THAT CAN BE CROSS-LINKED TO FORM A SILICONE RESIN COMPOSITE MATERIAL

(71) Applicant: Wacker Chemie AG, Munich (DE)

(72) Inventors: Jens Lambrecht, Altötting (DE); Frank Sandmeyer, Burgkirchen (DE); Markus Winterer, Simbach (DE)

(73) Assignee: Wacker Chemie AG, Munich (DE)

(21) Appl. No.: 17/612,194

(22) PCT Filed: May 17, 2019
(86) PCT No.: PCT/EP2019/062822

§ 371 Date: Nov. 17, 2021

(51) Int. Cl. C08G 77/16; C08L 83/04; C08K 7/14; C08K 7/02; C08K 5/56; C08G 77/00; C08G 77/20; C08G 77/12

(52) U.S. Cl. CPC C08G 77/16; C08L 83/04; C08K 7/14; C08G 77/12; C08K 5/56; C08G 77/80; C08G 77/20; C08K 7/02

(57) ABSTRACT

Silicone resin having the general formula

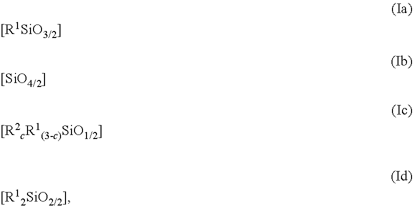

where R¹ are identical or independently different monovalent hydrocarbon radicals or —OH and R² are identical or independently different monovalent organofunctional hydrocarbon radicals, olefinically unsaturated hydrocarbon radicals or a hydrogen radical. Where R² is bonded to the silicon atom via a carbon atom and R² is a hydrogen radical that is bonded to the silicon atom directly. Where c is 0 or 1, (Ic) present in not less than 5 mol %, (Ia) present in not less than 20 mol %, (Ib) present in not more than 20 mol %, (Id) present in not more than 20 mol %. Not less than 1 mol % of units (Ic) contain a radical R² that is a hydrogen radical and not less than 1 mol % of (Ic) contain radicals R² that is an olefinically unsaturated hydrocarbon radical and includes pulverulent and fibrous fillers.

The invention relates to a silicone resin composition (S) that comprises the silicone resin (i) containing hydrogen radicals and olefinically unsaturated hydrocarbon radicals and also both pulverulent fillers and fibrous fillers.

Silicones are high-performance materials for many applications, particularly for many electrical insulation purposes. They combine excellent UV resistance, resistance to thermal stress, water repellence and stability to hydrolysis. There is practically no organic polymer that can cover this combination of features. A number of silicone resins are already available as duromeric variants, but their usability in the insulating parts industry is severely limited by their presentation (no finished products, not solvent-free).

There are no known castable or mouldable silicone resins that combine relatively low viscosity with attractive mechanical properties and allow processing with existing machines and technologies.

DE102015200704A1 describes the synthesis of castable silicone resins containing Si—H and Si-vinyl units that can be cured by self-crosslinking.

The object of the invention was to create filler-containing silicone resin systems that can be processed with existing machines and technologies and have improved mechanical properties after curing.

The invention provides a silicone resin composition (S) that comprises the silicone resin (i) consisting of units of the general formula (Ia), (Ib), (Ic) and (Id)

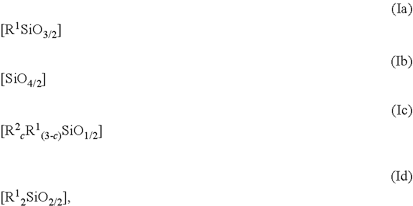

where
R¹ are identical or independently different monovalent hydrocarbon radicals or —OH,
R² are identical or independently different monovalent organofunctional hydrocarbon radicals, olefinically unsaturated hydrocarbon radicals or a hydrogen radical, where the radical R² is bonded to the silicon atom via a carbon atom, and when R² is a hydrogen radical, this is bonded to the silicon atom directly,
c has the value 0 or 1,
   with the proviso that
      units (Ic) are present in a content of not less than 5 mol %,
      units (Ia) are present in a content of not less than 20 mol %,
      units (Ib) are present in a content of not more than 20 mol %,
      units (Id) are present in a content of not more than 20 mol %,
      not less than 1 mol % of units (Ic) contain a radical R² that is a hydrogen radical,
      not less than 1 mol % of units contain a radical R² that is an olefinically unsaturated hydrocarbon radical,
and also comprises both pulverulent fillers and fibrous fillers.

The silicone resin composition (S) is particularly well suited for the production of moulded parts, since it can be present as a ready-to-use, in particular single-component composition, has a long pot life and low viscosity, can be used solvent-free, is processable using existing standard machines for resins and does not require special labelling. The silicone resin composition (S) is self-crosslinkable.

Surprisingly, the mechanical properties of the cured silicone resin composition (S), in particular the flexural strength and tensile strength, are improved by the presence of both fibrous fillers and pulverulent fillers in a synergistic manner.

Moreover, the incorporation of the fibrous fillers is facilitated by the presence of the pulverulent fillers and the processability of the silicone resin composition (S) is considerably improved by comparison with silicone resin compositions comprising purely fibrous fillers. Compositions of the latter type have a felt-like consistency and cannot be processed into moulded parts having reproducible properties.

The silicone resin (i) can be produced as described in DE102015200704A1.

The viscosity of the silicone resin (i) is preferably between 20 and 100 000 mPas, more preferably between 30 and 50 000 mPas, even more preferably between 50 and 10 000 mPas, in particular between 100 and 3000 mPas. All cited viscosities apply to a temperature of 25° C. and standard pressure of 1013 mbar.

The silicone resins (i) are by preference those having a molecular weight Mw of not less than 500, preferably not less than 600, more preferably not less than 700, in particular not less than 800, the polydispersity being not more than 20, preferably not more than 18, more preferably not more than 16, in particular not more than 15.

The silicone resin (i) contains preferably not less than 10 mol %, more preferably not less than 15 mol %, even more preferably not less than 25 mol %, in particular not less than 35 mol % and preferably not more than 90 mol %, of units of the general formula (Ic).

The silicone resin (i) contains preferably not less than 25 mol %, more preferably not less than 30 mol %, in particular not less than 35 mol % and preferably not more than 90 mol %, of units of the general formula (Ia).

The silicone resin (i) contains preferably not more than 15 mol %, more preferably not more than 10 mol %, in particular not more than 5 mol %, of units of the general formula (Ib).

The silicone resin (i) contains preferably not more than 15 mol %, more preferably not more than 10 mol %, in particular not more than 5 mol %, of units of the general formula (Id).

In the silicone resin (i), preferably not less than 5 mol %, more preferably not less than 10 mol %, in particular not less than 15 mol %, of units of the general formula (Ic) contain a radical R² that is a hydrogen radical.

In the silicone resin (i), preferably not less than 5 mol %, more preferably not less than 10 mol %, in particular not less than 15 mol %, of units of the general formula (Ic) contain a radical R² that is an olefinically unsaturated hydrocarbon radical.

In the silicone resin (i), the ratio of units of the general formula (Ic) in which the radical R² is an olefinically unsaturated hydrocarbon radical to units in which the radical R² is a hydrogen radical is preferably 3:1 to 1:2, in particular 2:1 to 1:1.1.

Examples of organofunctional radicals R² are for instance glycol radicals and organic functional groups from the group of phosphoric esters, phosphorous esters, epoxide functions, methacrylate functions, carboxyl functions, acrylate functions, olefinically or acetylenically unsaturated hydrocarbons or a hydridic hydrogen bonded to silicon.

These functional groups may optionally be substituted.

The radicals R² may optionally terminate in hydroxy-, alkyloxy- or trimethylsilyl groups. In the main chain, nonadjacent carbon atoms may be replaced by oxygen atoms.

Except when they are a hydrogen atom, which is always bonded to silicon, the functional groups R² are generally not directly bonded to the silicon atom. An exception thereto are olefinic or acetylenic groups, in particular the vinyl group, which can likewise be directly bonded to silicon. The remaining functional groups R² are bonded to the silicon atom via spacer groups, the spacer always being Si—C-bonded. The spacer is here a divalent hydrocarbon radical comprising 1 to 30 carbon atoms in which nonadjacent carbon atoms may be replaced by oxygen atoms and which may also contain other heteroatoms or heteroatom groups, although this is not preferable.

The methacrylate group, the acrylate group and the epoxy group are preferably bonded to the silicon atom via a spacer, the spacer consisting of a divalent hydrocarbon radical comprising 3 to 15 carbon atoms, preferably 3 to 8 carbon atoms, in particular 3 carbon atoms and optionally in addition not more than 1 to 3 oxygen atoms, preferably not more than 1 oxygen atom.

The carboxyl group is preferably bonded to the silicon atom via a spacer consisting of a divalent hydrocarbon radical comprising preferably 3 to 30 carbon atoms, in particular 3 to 20 carbon atoms, in particular 3 to 15 carbon atoms and optionally in addition not more than 1 to 3 oxygen atoms, preferably not more than 1 oxygen atom, in particular no oxygen atom.

Hydrocarbon radicals R² that contain heteroatoms are, for example, carboxylic acid radicals of the general formula (II)

Y¹—COOH (II),

where Y¹ is preferably a divalent linear or branched hydrocarbon radical having up to 30 carbon atoms, where Y¹ may also contain olefinically unsaturated groups or heteroatoms and the atom of radical Y¹ directly attached to the silicon is a carbon atom. Heteroatom-containing fragments that may typically be present in the radical Y¹ are —N(R⁵)—C(═O)—, —C—O—C—, —N(R⁵)—, —C(═O)—, —O—C(═O)—, —C—S—C—, —O—C(═O)—O—, —N(R⁵)—C(═O)—N(R⁵)—, in which unsymmetrical radicals may be incorporated in the radical Y¹ in both possible directions, wherein R⁵ is a hydrocarbon radical or hydrogen.

If the radical according to formula (II) is generated e.g. by ring opening and condensation of a maleic anhydride at a silanol function, it would be a radical of the form (cis)-C═C—COOH.

Hydrocarbon radicals R² that contain heteroatoms are additionally, for example, carboxylic ester radicals of the general formula (IX)

Y¹—C(═O)O—Y² (IX),

where Y¹ is as defined above. The radical Y² is preferably hydrocarbon radicals and is accordingly, independently of R′, preferably as defined for R¹. Y² may also contain further heteroatoms and organic functions, such as double bonds or oxygen atoms, although this is not preferable.

The carboxylic ester radical R² may also be attached the other way round, i.e. be a radical of the form

Y¹—OC(═O)Y².

Examples of further organofunctional radicals R² are acryloyloxy and methacryloyloxy radicals of methacrylic or acrylic esters such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate. Particular preference is given to methyl acrylate, methyl methacrylate, n-butyl acrylate, isobutyl acrylate, t-butyl acrylate, 2-ethylhexyl acrylate and norbornyl acrylate.

Examples of preferred olefinically unsaturated hydrocarbon radicals R² are those of the formula (XIII) and (XIV)

Y¹—CR⁷═CR⁸R⁹ (XIII)

Y¹—C≡CR¹⁰ (XIV),

where Y¹ is as defined above and may additionally be a chemical bond, which particularly in formula (IX) is particularly preferred, and the radicals R⁷, R⁸, R⁹ and R¹⁰ are preferably a hydrogen atom or a C1-C8 hydrocarbon radical that may optionally contain heteroatoms, the most preferred radical being the hydrogen atom. Particularly preferred as radical (XIII) are the vinyl radical, the propenyl radical and the butenyl radical, in particular the vinyl radical. The radical (XIII) may also be a dienyl radical attached via a spacer, for example a 1,3-butadienyl or isoprenyl radical attached via a spacer.

Particularly preferred organofunctional radicals R² are carboxylic acid-functional, vinyl-functional and epoxy-functional radicals and the hydrogen radical. In particular, the vinyl radical and hydrogen radical.

It is in principle conceivable for the silicone resins (i) to bear various organofunctional groups. However, this is possible only if the selected organic groups do not react with one another under normal storage conditions, i.e. storage for 6 months at 23° C. and 1013 mbar in closed containers with the exclusion of air and moisture. For example, combinations of vinyl groups and Si—H groups are possible, since their reaction with one another necessitates conditions substantially different from those of normal storage, for example a catalyst and elevated temperature. A suitable selection of combinations of functional groups can be easily established by those skilled in the art from the published literature on the chemical reactivity of organofunctional groups.

A particularly preferred combination of various organofunctional groups is that of hydridic hydrogen and olefinically unsaturated group, where, in the particularly preferred form, the olefinically unsaturated group is directly bonded to silicon. The most preferred olefinically unsaturated group is the vinyl group.

If a plurality of radicals R¹ or R² is present in a unit of the formula (Ic), these may independently be various radicals within the stated group of possible radicals, with the proviso that the above conditions for the organofunctional groups are met.

R¹⁷ may be as defined for R¹ or be —OH. Preferred hydrocarbon radicals R¹ are unsubstituted hydrocarbon radicals having 1 to 16 carbon atoms. Selected examples of the hydrocarbon radicals R¹ are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals such as the cyclopentyl, cyclohexyl, cycloheptyl and methylcyclohexyl radicals, aryl radicals, such as the phenyl, naphthyl, anthryl and phenanthryl radicals, alkaryl radicals, such as tolyl radicals, xylyl radicals and ethylphenyl radicals, and aralkyl radicals, such as the benzyl radical and the □-phenethyl radical, Particularly preferred hydrocarbon radicals R¹ are the methyl-, n-propyl- and phenyl radical.

The pulverulent fillers are preferably a finely-divided granulate consisting of many small, solid particles such as grains or spheres. The average particle size of the pulverulent fillers is preferably 0.1 μm to 0.3 mm, more preferably 0.5 μm to 100 μm, in particular 2 μm to 20 μm.

Examples of pulverulent fillers are non-reinforcing fillers, that is to say fillers having a BET surface area of up to 50 m²/g, such as quartz, diatomaceous earth, calcium silicate, zirconium silicate, zeolites, metal oxide powders, such as aluminium oxide, titanium oxide, iron oxide or zinc oxide or the mixed oxides thereof, barium sulfate, calcium carbonate, gypsum, silicon nitride, silicon carbide, boron nitride, glass powders and plastic powders; non-reinforcing fillers, that is to say fillers having a BET surface area of up to 50 m²/g, such as fumed silica, precipitated silica, carbon black, such as acetylene black and furnace black, and silicon-aluminium mixed oxides having a large BET surface area. The recited fillers may be hydrophobized, for example by treatment with organosilanes or organosiloxanes or by etherification of hydroxyl groups to alkoxy groups. It is possible to use a single type of pulverulent filler or a mixture of at least two pulverulent fillers.

The pulverulent filler may also be a pigment, such as earth pigments, e.g. chalks, ochres, umbers, green earths, mineral pigments, such as titanium dioxide, chrome yellow, minium, zinc yellow, zinc green, cadmium red, cobalt blue, organic pigments, such as sepia, Van Dyke brown, indigo, azo pigments, anthraquinoid, indigoid, dioxazine, quinacridone, phthalocyanine, isoindolinone and alkali blue pigments, many of the inorganic pigments also acting as fillers and vice versa.

The fibrous fillers consist preferably of particles in which the average ratio of length to diameter is preferably not less than 5:1, more preferably not less than 8:1, in particular not less than 12:1, and preferably not more than 10 000:1, more preferably not more than 1000:1.

Examples of fibrous fillers are natural fibres, such as plant fibres, e.g. cotton fibres, bamboo fibres, nettle fibres, hemp fibres or linen fibres, animal fibres, e.g. wool fibres, alpaca fibres, camel hair fibres, cashmere fibres, silk fibres or mohair fibres, and mineral fibres, e.g. asbestos, erionite, attapulgite, sepiolite and wollastonite.

Further examples of fibrous fillers are man-made fibres, such as fibres from natural polymers, e.g. fibres from regenerated cellulose, such as viscose, modal, e.g. fibres from cellulose esters, such as acetate and triacetate, e.g. protein fibres, such as protein fibres from regenerated natural protein of vegetable or animal origin, modified soybean protein fibres and casein fibres, e.g. polylactide, alginate and chitin; fibres from synthetic polymers, such as polyester, polyamide, polyimide, polyamide-imide, aramid, polyacrylic, PTFE, polyethylene, polypropylene, melamine and polystyrene;

fibres from inorganic substances, such as ceramic, glass, quartz, carbon and metal fibres.

The silicone resin composition (S) may comprise hydrosilylation catalyst. All known catalysts that catalyse the hydrosilylation reactions that take place during the crosslinking of addition-crosslinked silicone compositions may be used for this purpose.

The hydrosilylation catalyst is preferably selected from metals such as platinum, rhodium, palladium, ruthenium and iridium, preferably platinum, and compounds thereof. Preference is given to using platinum and platinum compounds. Particular preference is given to using platinum compounds that are soluble in polyorganosiloxanes. Examples of soluble platinum compounds used are platinum-olefin complexes of the formulas (PtCl₂.olefin)₂ and H(PtCl₃.olefin), with preference given to using alkenes having 2 to 8 carbon atoms, such as ethylene, propylene, isomers of butene and octene, or cycloalkenes having 5 to 7 carbon atoms, such as cyclopentene, cyclohexene and cycloheptene. Further soluble platinum catalysts are the platinum-cyclopropane complex of the formula (PtCl₂C₃H₆)₂, the reaction products of hexachloroplatinic acid with alcohols, ethers and aldehydes and mixtures thereof or the reaction product of hexachloroplatinic acid with methylvinylcyclotetrasiloxane in the presence of sodium bicarbonate in ethanolic solution. Particular preference is given to complexes of platinum with vinylsiloxanes such as sym-divinyltetramethyldisiloxane.

The hydrosilylation catalyst may be used in any desired form, for example also in the form of microcapsules comprising hydrosilylation catalyst, or polyorganosiloxane particles.

The content of hydrosilylation catalyst is preferably chosen such that the silicone resin composition (S) has a Pt content of 0.1-200 ppm by weight, preferably of 0.5-40 ppm by weight.

The silicone resin composition (S) may contain peroxides as crosslinkers. Examples are dibenzoyl peroxide, bis(2,4-dichlorobenzoyl) peroxide, dicumyl peroxide and 2,5-bis(tert-butylperoxy)-2,5-dimethylhexane and mixtures thereof, with preference given to bis(2,4-dichlorobenzoyl) peroxide and 2,5-bis(tert-butylperoxy)-2,5-dimethylhexane.

The content of peroxide is preferably chosen such that the silicone resin composition (S) has a peroxide content of 0.1% to 5% by weight, preferably of 0.5% to 2% by weight.

The silicone resin composition may be crosslinked purely by a hydrosilylation catalyst, by a peroxide, or by a combination of hydrosilylation catalyst and peroxide. If using a combination of hydrosilylation catalyst and peroxide, the procedure consists for example of preliminary crosslinking with the hydrosilylation catalyst at a relatively low temperature of for example 100° C. to 150° C., followed by curing with epoxide at a higher temperature, for example 160° C. to 210° C., or of curing at a single temperature of for example 150 to 200° C. without preliminary curing.

The silicone resin composition (S) may comprise further constituents such as plasticisers, adhesion promoters, soluble dyes, inorganic and organic pigments, fluorescent dyes, solvents such as those already mentioned above, fungicides, fragrances, dispersants, rheological additives, corrosion inhibitors, oxidation inhibitors, light stabilizers, heat stabilizers, flame-retarding agents, agents for influencing electrical properties, and agents for improving thermal conductivity.

Examples of solvents that may be used are ethers, in particular aliphatic ethers, such as dimethyl ether, diethyl ether, methyl t-butyl ether, diisopropyl ether, dioxane or tetrahydrofuran, esters, in particular aliphatic esters, such as ethyl acetate or butyl acetate, ketones, in particular aliphatic ketones, such as acetone or methyl ethyl ketone, sterically hindered alcohols, in particular aliphatic alcohols, such as isopropanol, t-butanol, amides, such as DMF, aromatic hydrocarbons such as toluene or xylene, aliphatic hydrocarbons, such as pentane, cyclopentane, hexane, cyclohexane, heptane, chlorinated hydrocarbons, such as dichloromethane or chloroform.

Solvents or solvent mixtures having a boiling point/boiling range of up to 120° C. at 0.1 MPa are preferred.

The preferred solvents are aromatic or aliphatic hydrocarbons.

The crosslinking of the silicone resins (i) in the silicone resin composition (S) is effected by hydrosilylation catalyst or by peroxides and, depending on the selection of organofunctional groups present, can additionally take place through further reactions such as condensation reactions or polymerization reactions.

The silicone resin composition (S) is particularly suitable for the production of hard solid products, such as shaped bodies, e.g. electronic components and cast shapes, sheet-like structures, such as coatings, filling materials for filling cavities or the like.

The meanings of all abovementioned symbols in the abovementioned formulas are in each case independent of one another. The silicon atom is tetravalent in all formulas.

In the following examples, unless otherwise stated in each case, all amounts and percentages are based on weight, all pressures are 101.3 kPa (abs.) and all temperatures are 20° C.

Test Methods:

Molecular Compositions:

Molecular compositions are determined by nuclear magnetic resonance spectroscopy (for terminology see ASTM E 386: High-resolution nuclear magnetic resonance (NMR) spectroscopy: Terms and symbols), with measurement of the ¹H nucleus.

Description of ¹H-NMR Measurement
Solvent: CDCl₃, 99.8%
Sample concentration: 50 mg/1 ml CDCl₃ in 5 mm NMR tubes

Measurement without addition of TMS, spectrum referenced to residual CHCl₃ in CDCl₃ at 7.24 ppm
Spectrometer: Bruker Avance I 500 or Bruker Avance HD 500
Probe: 5 mm BBO probe or SMART probe (Bruker)

Measurement Parameters:
Pulprog=zg30
TD=64 k
NS=64 or 128 (depending on sensitivity of probe)
SW=20.6 ppm
AQ=3.17 s
D1=5 s
SFO1=500.13 MHz
O1=6.175 ppm

Processing Parameters:
SI=32 k
WDW=EM
LB=0.3 Hz

Depending on the spectrometer type used, individual adjustments of the measurement parameters may be required.

Description of ²⁹Si-NMR Measurement
Solvent: C₆D₆ 99.8%/CCl₄ 1:1 v/v with 1% by weight of Cr(acac)₃ as relaxation reagent
Sample concentration: approx. 2 g/1.5 ml solvent in 10 mm NMR tubes
Spectrometer: Bruker Avance 300
Probe: 10 mm ¹H/¹³C/¹⁵N/²⁹Si glass-free QNP probe (Bruker)

Measurement Parameters:
Pulprog=zgig60
TD=64 k
NS=1024 (depending on sensitivity of probe)
SW=200 ppm
AQ=2.75 s
D1=4 s
SFO1=300.13 MHz
O1=−50 ppm

Processing Parameters:
SI=64 k
WDW=EM
LB=0.3 Hz

Depending on the spectrometer type used, individual adjustments of the measurement parameters may be required.

Determination of Viscosity:

Unless otherwise specified, viscosities are determined on a MCR302 rheometer from Anton Paar, D-Ostfildern in accordance with DIN EN ISO 3219 in rotation with a cone-plate measurement system. The measurements are carried out in the Newtonian range of the samples. Where samples show non-Newtonian behaviour, the shear rate is also given. Unless otherwise specified, all reported viscosities are at 25° C. and standard pressure of 1013 mbar.

Determination of Flexural Strength:

The flexural strength is determined in accordance with ISO 178 using a TA.HD.plus Texture Analyzer from Stable Micro Systems. Test rods having the dimensions 80×10×4 mm³ are rested on two supports and impacted by a movable punch. The test rods are produced by compressing the silicone resin composite at 165° C. for 10 min, demoulding and then heat-treating the finished test rods at 200° C. for 24 h.

Determination of Tensile Strength:

The tensile strength is determined on type 1B test rods in accordance with ISO 527-2 using a TA.HD.plus Texture Analyzer from Stable Micro Systems. The test rods are produced by compressing plates (thickness 4±0.2 mm) of the silicone resin composite at 165° C. for 10 min, demoulding and then heat-treating at 200° C. for 24 h. The test rods were milled out of these plates.

### EXAMPLES

### Example 1

The fillers are mixed homogeneously into 33.56 parts by weight of a self-crosslinking vinyl- and Si—H-functional methylphenyl resin composed of 46 mol % of TPh units (TPh=(C₆H₅)SiO_{3/2}), 27 mol % of MH units (MH=H(CH₃)₂SiO_{1/2}) and 27 mol % of VM units (VM=(C₂H₃)(CH₃)₂SiO_{1/2}) that additionally contains 160 ppm by weight of OH units attached to the TPh units in a statistical distribution such that a Si-vinyl content of 2.64 mmol/g and a Si—H content of 2.61 mmol/g are obtained. Into this are mixed 0.84 parts by weight of 2,5-(tert-butylperoxy)-2,5-dimethylhexane and 0.42 parts by weight of a platinum catalyst and the mixture is first compressed at 135° C. After storage at 200° C. for a further 24 h, the material has been completely cured.

### Example 2

The fillers are mixed homogeneously into 33.64 parts by weight of a self-crosslinking vinyl- and Si—H-functional methylphenyl resin composed of 46 mol % of TPh units (TPh=(C₆H₅)SiO_{3/2}), 27 mol % of MH units (MH=H(CH₃)₂SiO_{1/2}) and 27 mol % of VM units (VM=(C₂H₃)(CH₃)₂SiO_{1/2}) that additionally contains 160 ppm by weight of OH units attached to the TPh units in a statistical distribution such that a Si-vinyl content of 2.64 mmol/g and a Si—H content of 2.61 mmol/g are obtained. Into this is mixed 1 part by weight of 2,5-(tert-butylperoxy)-2,5-dimethylhexane and the mixture is compressed at 165° C. After storage at 200° C. for a further 24 h, the material has been completely cured.

### Example 3

The fillers are mixed homogeneously into 33.82 parts by weight of a self-crosslinking vinyl- and Si—H-functional methylphenyl resin composed of 46 mol % of TPh units (TPh=(C₆H₅)SiO_{3/2}), 27 mol % of MH units (MH=H(CH₃)₂SiO_{1/2}) and 27 mol % of VM units (VM=(C₂H₃)(CH₃)₂SiO_{1/2}) that additionally contains 160 ppm by weight of OH units attached to the TPh units in a statistical distribution such that a Si-vinyl content of 2.64 mmol/g and a Si—H content of 2.61 mmol/g are obtained. Into this is mixed 0.5 parts by weight of a platinum catalyst and the mixture is compressed at 135° C. After storage at 200° C. for a further 24 h, the material has been completely cured.

### Example 4 (Noninventive)

The procedure described in Example 2 is followed, but without the addition of fillers. After crosslinking for 15 minutes at 165° C., crosslinked resin without reinforcing fillers shows low mechanical strength, which can be improved slightly through heat-treatment. The flexural strength of the crosslinked resin before heating is only 1 MPa, the tensile strength is less than 1 N/mm⁻². Heat-treatment increases the mechanical strength. After heat-treating at 200° C. for 24 h, flexural strength of 8 MPa and tensile strength of 6 N/mm⁻² are achieved. The resin nonetheless cannot be used for producing moulded parts, because it is brittle.

### Example 5 (Noninventive)

The procedure described in Example 2 is followed. The mixture of binder with quartz customary in casting resins results, as expected, in an improvement in mechanical properties. For example, a mixture of 40 parts of the described silicone resin with 65 parts of quartz of the Sikron SF 4000 type (cristobalite, average particle size 5 μm) achieves, after heat-treating at 200° C. for 24 h, a flexural strength of 25 MPa and a tensile strength of 19 N/mm⁻².

### Example 6 (Noninventive)

The procedure described in Example 2 is followed. The experimental incorporation of up to 65 parts of milled short glass fibres (Lanxess MF 7986 with diameter 16 μm, average fibre length 220 μm, type E glass (DIN 1259)) into the silicone resin binder results always in the formation of a sometimes felt-like, highly viscous, inhomogeneous, unprocessable mixture. On standing for a short period and particularly after shaking, the binder separates from the fibres.

The result of the experimental crosslinking demonstrates that it is not possible to produce moulded parts having a homogeneous fibre-binder distribution.

### Example 7 (Inventive)

The procedure described in Example 2 is followed. A mixture of 25 parts of short glass fibres, 25 parts of quartz and 15 parts of colloidal silica (Wacker HDK H 2000) is incorporated into the silicone resin as binder and the mixture is crosslinked and heat-treated at 200° C. for 24 h. A flexural strength of >50 MPa and tensile strength of >25 N/mm⁻² are achieved.

The additional addition of quartz powder to the glass fibre-binder mixture in accordance with Example 6 surprisingly affords a mixture that is no longer felt-like and in which the binder no longer has a tendency to separate, and which has lower viscosity than before addition of the quartz powder, is easily processed and can be used to produce homogeneous shaped bodies. The mechanical properties were improved further compared with use of quartz on its own. In the silicone resin-binder mixture, contrary to expectations it was found that glass fibres and quartz, and even the addition of colloidal silica, results in a further improvement in appearance (no separation), in processability and in mechanical properties.

1-9. (canceled)

10. A silicone resin composition, comprising:
wherein the silicone resin composition comprises a silicone resin (i) consisting of units of the general formula (Ia), (Ib), (Ic) and (Id) 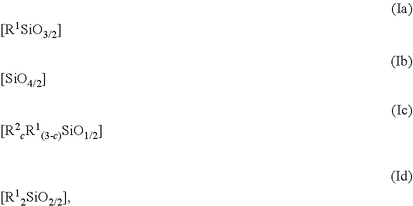
wherein R¹ are identical or independently different monovalent hydrocarbon radicals or —OH;
wherein R² are identical or independently different monovalent organofunctional hydrocarbon radicals, olefinically unsaturated hydrocarbon radicals or a hydrogen radical, where the radical R² is bonded to the silicon atom via a carbon atom, and when R² is a hydrogen radical, this is bonded to the silicon atom directly;
wherein c has the value 0 or 1;
wherein units (Ic) are present in a content of not less than 5 mol %;
wherein units (Ia) are present in a content of not less than 20 mol %;
wherein units (Ib) are present in a content of not more than 20 mol %;
wherein units (Id) are present in a content of not more than 20 mol %;
wherein not less than 1 mol % of units (Ic) contain a radical R² that is a hydrogen radical; and
wherein not less than 1 mol % of the units (Ic) contain a radical R² that is an olefinically unsaturated hydrocarbon radical and also comprises both pulverulent fillers and fibrous fillers.

11. The silicone resin composition of claim 10, wherein in the silicone resin (i) the ratio of units of the general formula (Ic) in which the radical R² is an olefinically unsaturated hydrocarbon radical to units in which the radical R² is a hydrogen radical is 3:1 to 1:2.

12. The silicone resin composition of claim 10, wherein the pulverulent fillers have an average particle size from 0.1 μm to 0.3 mm.

13. The silicone resin composition of claim 10, wherein the pulverulent fillers are selected from fillers having a BET surface area of up to 50 m²/g and fillers having a BET surface area of not less than 50 m²/g.

14. The silicone resin composition of claim 10, wherein the fibrous fillers consist of particles in which the average ratio of length to diameter is not less than 5:1.

15. The silicone resin composition of claim 10, wherein the fibrous fillers are selected from natural fibres, man-made fibres and fibres from inorganic substances.

16. The silicone resin composition of claim 10, wherein the silicone resin comprises hydrosilylation catalyst selected from the metals platinum, rhodium, palladium, ruthenium and iridium and compounds thereof.

17. The silicone resin composition of claim 10, wherein the silicone resin comprises peroxide as crosslinker.

18. The silicone resin composition of claim 10, wherein a solid product is produced from the silicone resin composition.
